(19) United States
(12) Patent Application Publication
(10) Pub. No.: US 2018/0363945 A1
(43) Pub. Date: Dec. 20, 2018

(54) WASHER FLUID HEATING ASSEMBLY AND HEATING METHOD

(71) Applicant: Ford Global Technologies, LLC, Dearborn, MI (US)

(72) Inventors: Paul Kenneth Dellock, Northville, MI (US); James J. Surman, Clinton Township, MI (US); Stuart C. Salter, White Lake, MI (US); Jose Garcia Crespo, Bloomfield Township, MI (US); Brad Napier Doman, Ann Arbor, MI (US)

(21) Appl. No.: 15/625,106

(22) Filed: Jun. 16, 2017

(51) Int. Cl. F24H 1/10; H05B 1/02; B60S 1/48; B60S 1/52

(52) U.S. Cl. CPC F24H 1/103; B60S 1/52; B60S 1/488; H05B 1/0236

(57) ABSTRACT

An exemplary washer fluid heating assembly includes an outer layer about an inner layer of a hose. The inner layer provides an outer boundary of a fluid flow path. A heating element is held by the inner layer. An exemplary washer fluid heating method includes conveying a fluid along a fluid flow path within a layer of a hose, and heating the fluid with a heating element held by the inner layer. The heating element provides a portion of an outer boundary of the fluid flow path.

### TECHNICAL FIELD

This disclosure relates generally to heating washer fluid for a vehicle.

### BACKGROUND

Many vehicles use washer fluid to clean contaminants from a windshield or another window. Some vehicles use washer fluid to clean contaminants from cameras and sensors of the vehicle. The contaminants can be dirt, dust, ice, etc. The washer fluid can be sprayed through nozzles onto a desired area of the vehicle.

Some vehicles heat the washer fluid, which helps to remove the contaminants. Known systems for heating washer fluid are expensive and complex. Further, the known systems may require significant time to raise a temperature of the washer fluid to a desired level.

### SUMMARY

A washer fluid heating assembly according to an exemplary aspect of the present disclosure includes, among other things, an outer layer about an inner layer of a hose. The inner layer provides an outer boundary of a fluid flow path. A heating element is held by the inner layer.

In a further non-limiting embodiment of the foregoing washer fluid heating assembly, the inner layer provides the outer boundary about an entire circumference of the fluid flow path.

In a further non-limiting embodiment of any of the foregoing washer fluid heating assemblies, the inner layer has a material composition including a base material and an additive that is more thermally conductive than the base material.

In a further non-limiting embodiment of any of the foregoing washer fluid heating assemblies, the material composition of the inner layer is a first material composition, and the outer layer has a second material composition different than the first material composition.

In a further non-limiting embodiment of any of the foregoing washer fluid heating assemblies, the base material is a thermoplastic vulcanizate.

In a further non-limiting embodiment of any of the foregoing washer fluid heating assemblies, the additive comprises graphite.

In a further non-limiting embodiment of any of the foregoing washer fluid heating assemblies, the heating element is configured to heat a fluid within the fluid flow path.

In a further non-limiting embodiment of any of the foregoing washer fluid heating assemblies, the heating element directly contacts a fluid within the fluid flow path such that the heating element provides a portion of the outer boundary.

In a further non-limiting embodiment of any of the foregoing washer fluid heating assemblies, the heating element comprises a first heating element on a first side of the fluid flow path and a second heating element on an opposing, second side of the fluid flow path.

In a further non-limiting embodiment of any of the foregoing washer fluid heating assemblies, the heating element comprises a Nichrome resistance wire.

In a further non-limiting embodiment of any of the foregoing washer fluid heating assemblies, the inner layer and the heating element together provide an extruded component.

In a further non-limiting embodiment of any of the foregoing washer fluid heating assemblies, the hose is a first hose, and the assembly further includes an electrically conductive connector fluidly coupling the first hose to a second hose.

In a further non-limiting embodiment of any of the foregoing washer fluid heating assemblies, the electrically conductive connector comprises a nylon blended with a metal or metal alloy.

In a further non-limiting embodiment of any of the foregoing washer fluid heating assemblies, a nozzle is fluidly coupled to the connector. The nozzle is configured to convey fluid from the fluid flow path to an area of a vehicle.

In a further non-limiting embodiment of any of the foregoing washer fluid heating assemblies, the fluid flow path conveys a washer fluid that removes contaminants from an area of a vehicle.

A washer fluid heating method according to another exemplary aspect of the present disclosure includes, among other things, conveying a fluid along a fluid flow path within a layer of a hose, and heating the fluid with at least one heating element held by the inner layer. The heating element provides at least a portion of an outer boundary of the fluid flow path.

A further non-limiting embodiment of the foregoing method includes adjusting the heating in response to a temperature of the fluid.

In a further non-limiting embodiment of any of the foregoing methods, the layer is an inner layer of the hose, and the inner layer is positioned within an outer layer.

A further non-limiting embodiment of the foregoing method includes directly contacting the fluid with the at least one heating element.

In a further non-limiting embodiment of any of the foregoing methods, the at least one heating element and the layer together provide an extruded component.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 shows a front view of a vehicle incorporating a washer fluid heating assembly according to an exemplary embodiment of the present disclosure.

FIG. 2 shows a partially schematic view of the washer fluid heating assembly of FIG. 1.

FIG. 3 shows a section through a hose of the washer fluid assembly taken along Line III-III in FIG. 2.

FIG. 4 shows the section of FIG. 3 in perspective with an outer layer of the hose partially removed to reveal an inner layer of the hose.

### DETAILED DESCRIPTION

This disclosure relates to heating washer fluid with a washer fluid heating assembly. The heating can occur within a hose of the washer fluid heating assembly.

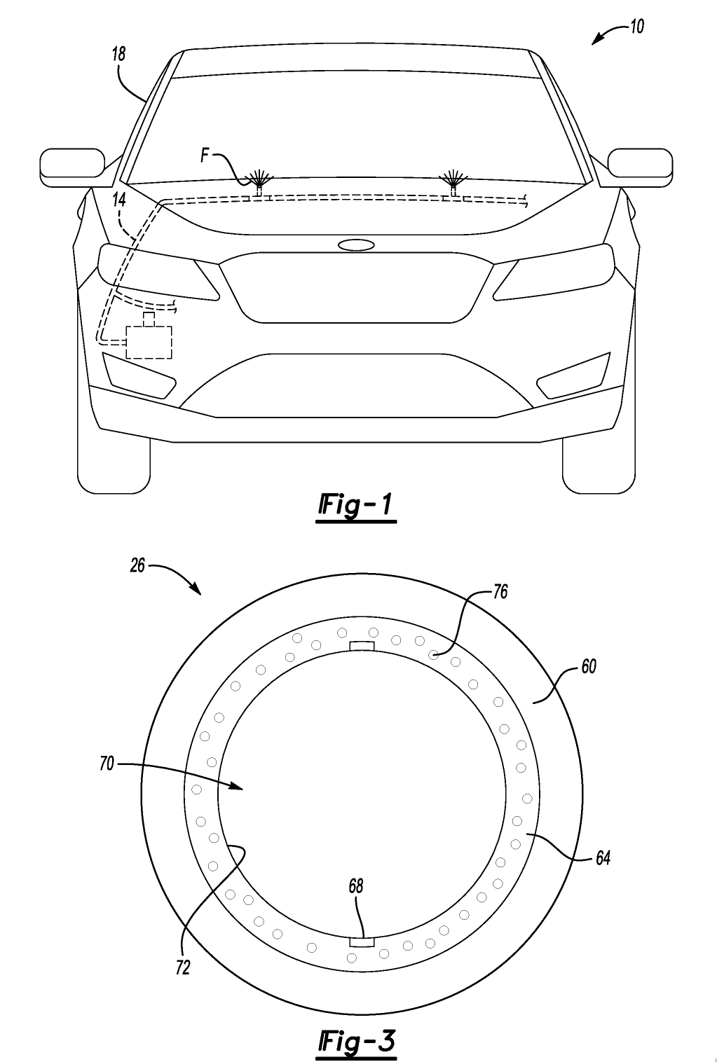

Referring to FIG. 1, an exemplary vehicle 10 includes a washer fluid heating assembly 14. In this exemplary embodiment, the washer fluid heating assembly 14 can, when prompted, direct a fluid F against a windshield 18. The fluid F can clean the windshield 18 by removing contaminants from the windshield 18, such as dust, dirt, or ice. The washer fluid heating assembly 14 can heat the fluid F to facilitate removal of the contaminants.

In this example, the washer fluid heating assembly 14 directs the fluid F in response to a command from an operator, such as an operator actuating a switch within a passenger compartment of the vehicle 10. The washer fluid heating assembly 14 can instead, or additionally, direct the fluid F automatically in response to some condition other than a direct command from an operator. For example, the washer fluid heating assembly 14 could direct the fluid F against the windshield 18 in response to the vehicle 10 starting remotely and detecting conditions where ice on the windshield 18 is likely.

The washer fluid heating assembly 14 is shown in connection with the windshield 18. In other examples, the washer fluid heating assembly 14 could be utilized to instead, or additionally, spray fluid F on other windows and areas of the vehicle 10. For example, the washer fluid heating assembly 14 could direct the fluid F against a rear window of the vehicle 10, or to a camera or sensor on the vehicle 10. The fluid F, in such examples, would facilitate removal of contaminants from the rear window, the camera, or the sensor.

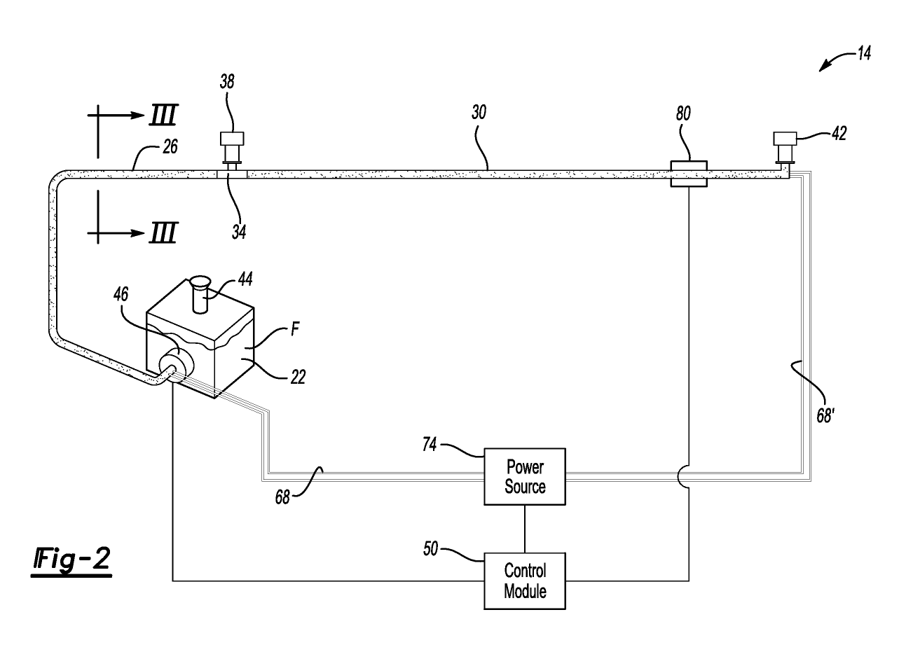

Referring now to FIG. 2, the washer fluid heating assembly 14, according to an exemplary embodiment of the present disclosure, includes a fluid reservoir 22, a first hose assembly 26, a second hose assembly 30, a connector 34, a first nozzle 38, and a second nozzle 42. The fluid reservoir 22 can include an inlet conduit 44. When required, an operator can fill the fluid reservoir 22 with fluid F through the inlet conduit 44 to replenish a supply of the fluid F.

The connector 34 receives fluid F from the first hose assembly 26. The connector 34 then directs a first portion of the fluid to the first nozzle 38, and a second portion of the fluid to the second hose assembly 30. In this example, the connector 34 is a tee connector.

The first hose assembly 26 conveys fluid F from the fluid reservoir 22 to the connector 34. The second hose assembly 30 conveys some of the fluid F from the connector 34 to the second nozzle 42.

The first nozzle 38 sprays the first portion of the fluid F against a passenger side area of the windshield 18. The second nozzle 42 sprays the second portion of the fluid F against a driver side area of the windshield 18.

The exemplary washer fluid heating assembly 14 additionally includes a pump 46 and a control module 50. The pump 46 activates in response to commands from the control module 50. When activated, the pump 46 moves fluid F from the fluid reservoir 22 through the first hose assembly 26 and other portions of the washer fluid heating assembly 14. The pump 46, in this example, is adjacent the fluid reservoir 22. In other examples, the pump 46 is located elsewhere within the washer fluid heating assembly 14.

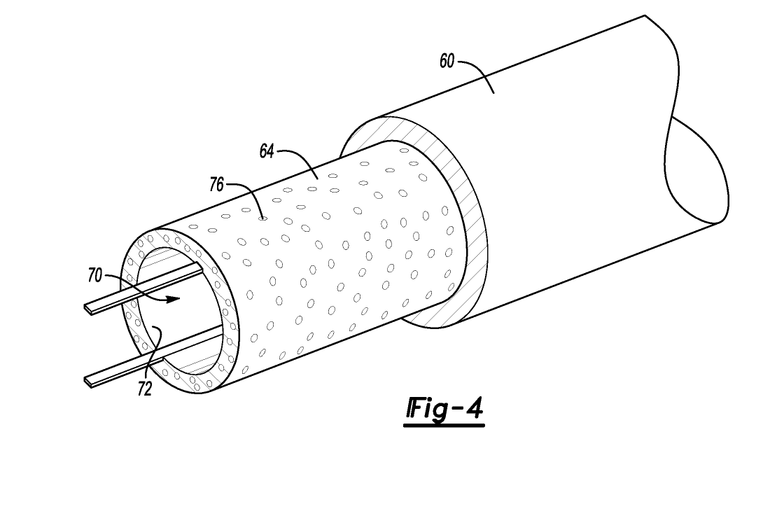

Referring to FIGS. 3 and 4 with continuing reference to FIG. 2, the first hose assembly 26 generally includes an outer layer 60, an inner layer 64, and at least one heating element 68. The second hose assembly 30 is constructed similarly to the first hose assembly 26 shown in FIGS. 3 and 4.

The first hose assembly 26 provides a fluid flow path 70 for conveying the fluid F. A direction of flow along the fluid flow path 70 extends out of the page in FIG. 3. In this example, at a given cross-section taken perpendicular to the direction of flow, the fluid flow path 70 has an outer boundary 72 primarily provided by the inner layer 64. The heating element 68, in this example, also provides part of the outer boundary 72. In other examples, the heating element 68 is recessed further within the inner layer 64 such that the outer boundary 72 is provided entirely by the inner layer 64, but the heating element 68 is still directly adjacent the fluid flow path 70.

The heating element 68 can selectively activate to heats the fluid F moving along the fluid flow path 70 of the first hose assembly 26. The heating element 68 generates thermal energy in response to a voltage from the power source 74. The control module 50 can control the power source 74 to selectively apply voltage to the heating element 68 to generate thermal energy. In some examples, the control module 50 commands the power source 74 to heat the heating element 68 in response to a particular environmental condition, such as a temperature below a threshold value where ice could occur on the windshield 18.

Positioning the heating element 68 directly adjacent the fluid flow path 70 can facilitate a transfer of thermal energy from the heating element 68 to the fluid F. In this example, the heating element 68 provides part of the outer boundary 72 and is thus directly exposed to the fluid F carried by the first hose assembly 26. When the heating element 68 is positioned in this way, should the heating element 68 become dislodged from the inner layer 64, the heating element 68 would likely move to within the fluid flow path 70. Flow of the fluid F could then move about a circumferential perimeter of the heating element 68, which can further facilitate thermal energy transfer from the heating element 68 to the fluid F.

The outer layer 60 electrically and thermally isolates the inner layer 64 and the heating element 68. The outer layer 60 also protects the inner layer 64 and the heating element 68. In some examples, the outer layer 60 can strengthen the second hose assembly 30. The outer layer 60 is, in this example, made of a thermoplastic vulcanizate (TPV) material.

The inner layer 64 is made of material composition that facilitates conduction of thermal energy. The inner layer 64 is used to distribute thermal energy from the heating element 68 about the fluid flow path 70 to further facilitate movement of thermal energy to the fluid F and to avoid “hot spots” within the fluid F.

The example inner layer 64 includes TPV, but has a material composition differing from the material composition of the outer layer 60. In one specific non-limiting embodiment, the inner layer 64 is made of TPV incorporating an additive 76, such as expanded graphite. The inner layer 64 can be, for example, twenty-percent expanded graphite, which has been found to increase an in-plane heat conductivity of the inner layer 64 about 3.0 Watts/meter-Kelvin above TPV without an expanded graphite additive. Unfilled thermoplastics can have a thermal conductivity of from 0.2 to 0.4 Watts/meter-Kelvin.

The graphite additive, in this exemplary embodiment, is a high aspect ratio expanded graphite, which may be even more thermally conductive than conventional carbon materials, such as standard graphite and carbon fibers. An exemplary graphite additive suitable for incorporation within the inner layer 64 is sold under the trade name TIMREX® C-Therm.

While the exemplary embodiment utilizes the expanded graphite additive, other examples of the inner layer 64 could include other additives such as graphene, carbon nanotubes, or other carbon materials.

Again, the heating element 68 generates thermal energy that moves to the fluid F and to the inner layer 64. In some examples, heating the heating element 68 from 60 to 80 degree Celsius has been found to provide sufficient thermal energy for heating the fluid F.

The heating element 68 can be a nickel chromium material, which is nominally composed of eighty-percent nickel and twenty-percent chromium, and meets ASTM B267 standards for resistance wire.

In this exemplary non-limiting embodiment, the heating element 68 comprises two separate 24-gage Nichrome 80 resistance wire. The wires are circumferentially offset 180 degrees from each other, such that the wires are on opposite sides of the fluid flow path 70.

The resistance of each of the wires is about 1.6089 ohms per foot. To heat each wire from 60 to 80 degree Celsius, about 1 amp of current per foot of the resistance wire can be required.

The heating element 68 can be designed to withstand oxidation that is prone to occur when the heating element 68 is a metal-based material. For example, the heating element 68 could be coated to withstand oxidation.

The heating element 68 extends along the length of the first hose assembly 26 to the connector 34, and outside the first hose assembly 26 to a power source 74. A heating element 68′ extends along the length of the second hose assembly 30 to the connector 34, and outside the second hose assembly 30 to the power source 74. When activated, the power source 74 electrically powers the heating elements, 68′ to cause the heating elements, 68′ to generate thermal energy.

The connector 34, in this example, can be an electrically conductive material, such as a metal or metal-based material, or a material with an electrically conductive additive. This type of connector 34 is suitable for conducting electricity between the heating element 68 in the first hose assembly 26 and the heating element 68′ in the second hose assembly 30. The connector 34, when electrically conductive, provides a conductive path through the connector 34 between the heating element 68 and the heating element 68′.

In one specific non-limiting embodiment, the connector 34 is a nylon material blended with a metal or metal alloy. The connector 34 could, for example, by about eighty-percent nylon and twenty-percent stainless steel. The nylon can be an EMI 263 grade of nylon. This material composition has a volume resistivity of less than 1 ohm-centimeter and a surface resistivity of less than 1×10⁴ ohm/sq. This material composition makes the connector 34 more electrically conductive than a connector formed from exclusively conventional nylon, which has a volume resistivity of more than 1×10¹² ohm-centimeter and a surface resistivity of greater than 1×10¹² ohm\sq measured using ASTM D257. The modified nylon can increase the resistivity over the conventional nylon to facilitate communication of electrical current between the first hose assembly 26 and the second hose assembly 30. The electrical resistance within the connector 34 can also generate thermal energy to heat the fluid F.

In some exemplary embodiments, one or more temperature sensors 80 are incorporated into the washer fluid heating assembly 14 to monitor a temperature of the fluid F. The temperature sensors 80 are thermistors in some examples. The control module 50 may respond to, for example, feedback from the temperature sensor 80 monitoring a temperature of fluid F within the second hose assembly 30. If the monitored temperature exceeds a threshold value, the control module 50 can stop the power source 74 from powering the heating element 68 to prevent the fluid F within the heated washer fluid heating assembly 14 from overheating.

The fluid F can, in some examples, include water, alcohol, and a surfactant. Such fluid may boil at temperatures as low as 170° F. The control module 50, based on feedback from the temperature sensor 80, can selectively activate and deactivate the power source 74 to prevent such a fluid F from boiling. Although described as deactivating the power source 74 to prevent boiling, the control module 50 could control the heating by reducing power to the heating element 68 such that the heating element 68 generates less thermal energy.

The control module 50 may be equipped with executable instructions for interfacing with and commanding operation of various components of the washer fluid heating assembly 14, including initiating the pumping by activating the pump 46 and initiating the heating by activating the power source 74.

The control module 50 may include a processing unit and non-transitory memory for executing the various control strategies and modes of the washer fluid heating assembly 14. The processing unit, in an embodiment, is configured to execute one or more programs stored in the memory of the control module 50. A first exemplary program, when executed, may determine when to activate the pump 46, and whether to activate the power source 74. The control module 50 could also control various other functions associated with the washer fluid heating assembly 14, including deactivating the power source 74 to stop the heating of the fluid F, or reducing power to the power source 74 to lessen the heating of the fluid F.

In this example, the heating element 68 is extruded together with the materials forming the inner layer 64 and the outer layer 60. The inner layer 64, the outer layer 60, and the heating element thus provide an extruded component. After the extruding, the inner layer 64 and the outer layer 60 are formed, and the heating element 68 is held by the inner layer 64. A person having skill in this art would understand how to structurally distinguish an extruded component from nonextruded components, such as injection molded components.

In another example, the heating element 68 is extruded with the inner layer 64 such that the heating element and the inner layer 64 together provide an extruded component. The outer layer 60 is then added to an exterior of the inner layer 64.

Features of the disclosed examples include an assembly and method that can relatively quickly heat a washer fluid without requiring heating a washer fluid reservoir. The system and method can be used to replace existing washer fluid systems that do not heat washer fluid.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

1. A washer fluid heating assembly, comprising:
an outer layer about an innermost layer of a hose, the innermost layer providing an outer boundary of a fluid flow path, the innermost layer having a material composition including a base material and an additive that is more thermally conductive than the base material; and
at least one heating element held by the innermost layer.

2. The washer fluid heating assembly of claim 1, wherein the innermost layer provides the outer boundary about an entire circumference of the fluid flow path.

3. (canceled)

4. The washer fluid heating assembly of claim 1, wherein the material composition of the innermost layer is a first material composition and the outer layer has a second material composition different than the first material composition.

5. The washer fluid heating assembly of claim 1, wherein the base material is a thermoplastic vulcanizate.

6. The washer fluid heating assembly of claim 5, wherein the additive comprises graphite.

7. (canceled)

8. The washer fluid heating assembly of claim 1, wherein the at least one heating element directly contacts a fluid within the fluid flow path such that the at least one heating element provides a portion of the outer boundary.

9. The washer fluid heating assembly of claim 1, wherein the at least one heating element comprises a first heating element on a first side of the fluid flow path and a second heating element on an opposing, second side of the fluid flow path.

10. The washer fluid heating assembly of claim 1, wherein the at least one heating element comprises a Nichrome resistance wire.

11. The washer fluid heating assembly of claim 1, wherein the inner layer and the at least one heating element together provide an extruded component.

12. The washer fluid heating assembly of claim 1, wherein the hose is a first hose, and further comprising an electrically conductive connector fluidly coupling the first hose to a second hose.

13. The washer fluid heating assembly of claim 12, wherein the electrically conductive connector comprises a nylon blended with a metal or metal alloy.

14. The washer fluid heating assembly of claim 12, further comprising a nozzle fluidly coupled to the connector, the nozzle configured to convey fluid from the fluid flow path to an area of a vehicle.

15. The washer fluid heating assembly of claim 1, further comprising a washer fluid held within the fluid flow path, the washer fluid conveyed along the fluid flow path to remove contaminants from an area of a vehicle.

16. A washer fluid heating method, comprising:
conveying a washer fluid along a fluid flow path within an innermost layer of a hose; and
heating the washer fluid with at least one heating element held by the innermost layer, the at least one heating element providing at least a portion of an outer boundary of the fluid flow path.

17. The washer fluid heating method of claim 16, further comprising adjusting the heating in response to a temperature of the fluid.

18. The washer fluid heating method of claim 16, wherein the innermost layer is positioned within an outer layer.

19. The washer fluid heating method of claim 16, further comprising directly contacting the fluid with the at least one heating element.

20. The washer fluid heating method of claim 16, wherein the at least one heating element and the layer together provide an extruded component.

21. The washer fluid heating method of claim 16, wherein the innermost layer has a material composition that includes a base material and an additive that is more thermally conductive than the base material.

22. The washer fluid heating method of claim 16, wherein the hose is a first hose, and further comprising fluidly coupling the first hose to a second hose using an electrically conductive connector, the electrically conductive connector comprising a nylon blended with a metal or metal alloy.
